(19) United States
(12) Patent Application Publication
(10) Pub. No.: US 2009/0001812 A1
(43) Pub. Date: Jan. 1, 2009

(54) Fused Power Intercept

(76) Inventor: Dennis L. Brooks, Aurora, CO (US)

Correspondence Address: A LAW FIRM, P.C., 8753 YATES DRIVE, SUITE 215, WESTMINSTER, CO, 80031, US

(21) Appl. No.: 11/771,873

(22) Filed: Jun. 29, 2007

(51) Int. Cl. B60L 3/04; H01R 13/68

(52) U.S. Cl. 307/10.1; 439/620.29

(57) ABSTRACT

A modified vehicular fuse is disclosed wherein an end of a bus electrode can extend through a fuse housing where it may be connected to a wire and thereby provide an additional circuit. A removable cover on the modified vehicle fuse enables the fuse to be adapted to a multitude of uses. A cover can be optional, wherein the terminal extension can be protected in another manner. A circuit incorporating the modified vehicular fuse with a double U connector is also disclosed. The circuit may comprise a fuse comprising a shell and a pair of electrodes extending beyond the terminus of the shell, thus providing an additional fused circuit.

### FIELD OF ART

The disclosed device relates generally to the fused circuitry of vehicular electrical systems and more specifically to a circuit that integrates vehicle fuse components and associated connectors into a comprehensive circuit to function as a single unit which may be disassembled and assembled as desired.

### BACKGROUND

In general operation, fuses protect a vehicle from wiring and electrical equipment failures. A fuse is placed in an electrical circuit so that when current flow exceeds the rating of the fuse, it melts thereby disconnecting the circuit. When the element in the fuse melts, opening the circuit, it prevents other components of the electrical system from being damaged by the excessive current. The size of the metal fuse element determines the rating. These types of fuses are generally rated for circuits no higher than 24 volts direct current.

The transportation industry typically employs plug-in fuses (also knows as blade or spade fuses) consisting of a plastic body and two blades that fit into sockets in the fused circuitry of vehicular electrical systems. These fuses are commonly available in the industry as a) 10.9×3.6×16.3 mm Minifuses with ampere ratings of 2 A, 3 A, 4 A, 5 A, 7.5 A, 10 A, 15 A, 20 A, 25 A, 30 A; b) 19.1×5.1×18.5 mm ATC standard fuses with ampere ratings of 1 A, 2 A, 3 A, 4 A, 5 A, 7.5 A, 10 A, 15 A, 20 A, 25 A, 30 A, 40 A; and c) 29.2×8.5×34.3 mm Maxifuses with ampere ratings of 20 A, 30 A, 40 A, 50 A, 60 A, 70 A, 80 A. The size of the fuse element is typically calibrated very carefully so that when the rated current is exceeded, enough heat is generated to melt the fuse element and to break the circuit.

A fuse generally has a shell to house the terminals necessary to conduct current from the wire through the fuse. Terminals can be crimped or soldered to the wires so the wire is not easily pulled away from the terminal. Seals can be employed to prevent water, etc. from entering the connection once the connectors are locked together.

The disclosed device provides for a circuit that integrates vehicle fuse components and their associated connectors into a comprehensive circuit to function as a single unit which may be disassembled and assembled as desired. The system provides for a fuse connector capable of providing optimized contact pressures between the electrodes. A circuit fuse comprising two electrodes can be used in conjunction with the fuse and the connector disclosed herein to provide a system which operates in concert.

U.S. Pat. No. 6,482,040 to Brooks discloses a vehicle fusing assembly having a circuit connector, a bus connector, and one or more linear fuses connectable thereto. The linear fuse taught by Brooks can be made up of a female connector fuse unit or a male connector fuse unit as shown in FIGS. 10, 11, 12, 13, 14. Each of the units can be made up of a fuse element positioned between two half shells. The fuse link of the fuse element is positioned in a void space. Respective ends of the female or male electrode of the Brooks linear fuse extend from the enclosure.

U.S. Pat. No. 6,709,300 to Brooks discloses a female connector having a power part and a male electrode receiver. The male electrode receiver taught by Brooks can apply more uniformly distributed pressure on spade-type electrodes and provide a larger, more consistent surface contact. Enlarging and optimizing the contact area increases electrical and thermal conduction, thereby reducing heat produced at the junction between the electrodes and increasing the transfer of generated heat from the junction.

U.S. Pat. No. 6,457,995 to Brooks discloses a vehicle fuse block extender having a shell, a male bus electrode, and a shortened circuit electrode capable of fitting into the female electrode of a vehicular type fuse block. One or more accessory electrodes connect to the bus electrode through fuse segments and at least one connector.

### SUMMARY OF THE DISCLOSURE

The disclosed device comprises a modified vehicular fuse having a shell enclosing at least a portion of each of a bus electrode and a circuit electrode. An end of the bus electrode can extend through the shell where it may be connected to a wire and thereby provide an additional circuit. A removable cover on the modified vehicle fuse enables the fuse to be adapted to a multitude of uses. When a circuit is desired, a user may detach the removable cover and make a connection. The removable cover can be reusable or non-reusable depending on the application. In some cases, a cover can be optional.

The disclosed device comprises a fuse and connector combination comprising a fuse shell and a pair of electrodes with a fuse link between which extend beyond the terminus of the fuse shell. Within the shell are positioning projections capable of engaging a corresponding number of receiving slots located on the pair of electrodes and a void space to enclose the fuse link. The extended end can mate with a receiving end of a latchable connector.

The disclosed device further comprises a circuit having a modified vehicular fuse connectable to a wire and attached thereto by means of a double U connector. A distal end of the wire is connectable to a line fuse using a modified latchable connector. A latchable connector can also be used to join a load wire to the circuit fuse. Sealing boots can be mounted on the latchable connectors and the fuse ends to seal the fuse unit.

These and other advantages of the disclosed device will appear from the following description and/or appended claims, reference being made to the accompanying drawings that form a part of this specification wherein like reference characters designate corresponding parts in the several views.

### BRIEF DESCRIPTION OF THE FIGURES

FIG. 1 is an exploded view of one embodiment of the disclosed interconnection system.

FIG. 2A is a perspective view showing the disclosed modification of an existing fuse unit.

FIG. 2B is a perspective view of one embodiment of a removable cover that can be used in conjunction with the modified fuse of FIG. 2A.

FIG. 3A is a perspective view of one embodiment of the disclosed fuse connector.

FIG. 3B is a bottom plan view of the device shown in FIG. 3A.

FIG. 3C is a side view of the device shown in FIG. 3A.

FIG. 4A is a perspective view of one embodiment of the disclosed line circuit fuse.

FIG. 4B is a partial cut-away view of a lower portion of the device shown in FIG. 4A.

FIG. 4C is a perspective view of one embodiment of the disclosed fuse element that can be used in conjunction with the device shown in FIG. 4A, 4B.

FIG. 4D is a top plan view of the device shown in FIG. 4C being mounted on the device of FIG. 4B.

FIG. 4E is a side view of the device shown in FIG. 4A.

FIG. 5 is a perspective view of one embodiment of the disclosed connector.

FIG. 6 is a perspective view of one embodiment of the seal assembly.

Before explaining the embodiments of the disclosed device in detail, it is to be understood that the device is not limited in its application to the details of the particular arrangements shown, since the device is capable of other embodiments. Also, the terminology used herein is for the purpose of description and not of limitation.

### DESCRIPTION OF THE DISCLOSED FIGURES

The following description is provided to enable any person skilled in the art to make and use the disclosed apparatus. Various modifications, however, will remain readily apparent to those skilled in the art, since the generic principles of the present apparatus have been defined herein specifically to provide for a fused power interceptor device.

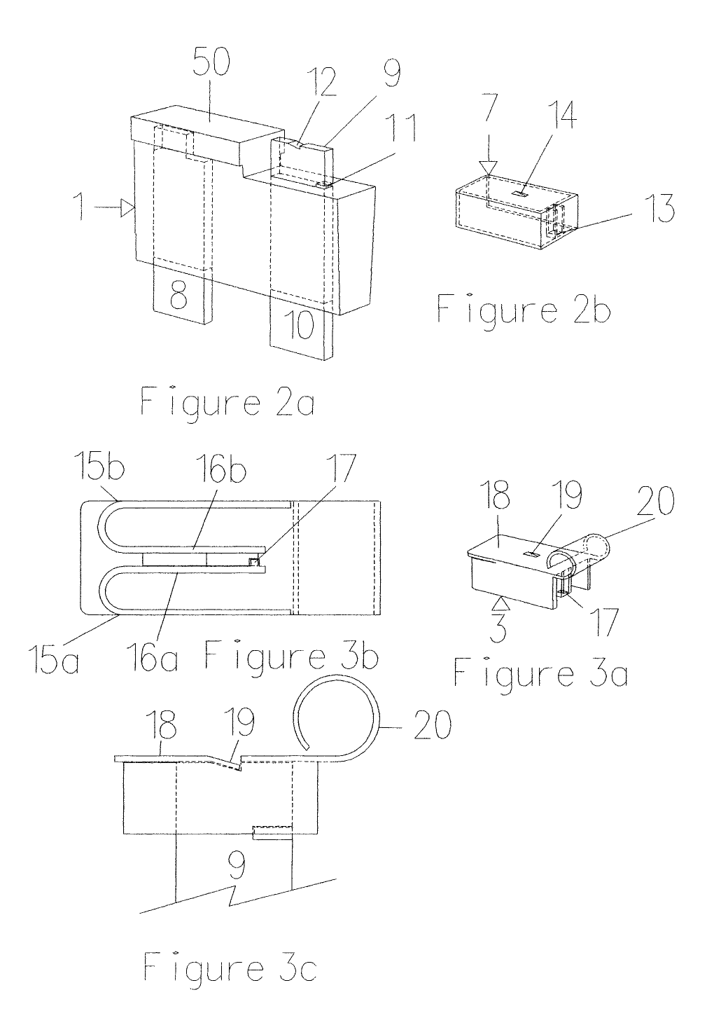

As shown in FIGS. 2A, 2B, the present device 1 comprises a vehicular fuse having a modified fuse housing 50 and a removable cover 7. Housing 50 can enclose at least a portion of a circuit electrode 8 and a bus electrode 10. An end of bus electrode 10 can extend through housing 50 to form a terminal extension 9. Although it is contemplated that the terminal extension can be manufactured by modifying the stamp which produces such terminals during manufacture, any known method of fabrication can be used. A counterpart end of circuit electrode 8 is shown enclosed within housing 50.

In this embodiment, terminal extension 9 comprises a notch 12 and a slot 11 which work in concert to accommodate cover 7 or connector 3 as will be further described below. A spring clip 14 engages notch 12. A suitably formed section 13 engages slot 11. As a result, cover 7 can be firmly held in place on housing 50. Because of the stability of the engagement contemplated between spring clip 14, notch 12, section 13, and slot 11, the cover may need to be forcibly removed, whereby the cover may need to be discarded. In some cases however, it may be appropriate to install a reusable cover. Thus, the combinations of spring clip 14 and notch 12 or section 13 and slot 11 could be used independently. Although such closure means such as the clip/notch combination and section/slot combination are described herein, various other configurations of removable covers are also possible in conjunction with, or independently from, one another.

Terminal extension 9 can be suitably dimensioned so that cover 7 (or connector 3) may fit flush with housing 50 when in use. In addition, cover 7 may be designed to accommodate the space surrounding terminal extension 9 to reproduce the fuse profile of a standard fuse, i.e. Minifuse, ATC standard, or a Maxifuse, thereby enabling the fuse to be used in a regular fashion. Cover 7 can be removed if and when a connector is to be used. As stated above, a cover can be optional. The terminal extension may be insulated in another manner.

In FIGS. 3A, 3B, 3C a connector 3 mechanism comprising two spring metal sections 15a, 15b is shown. Metal sections 15a, 15b are bent back upon themselves to each form a U-section having two legs. Adjacent legs 16a, 16b of each U-section form parallel contact surfaces, each capable of engaging a surface of terminal extension 9. Metal sections 15a, 15b can be sized to match the width of bus electrode 10 or its terminal extension 9. Connector 3 can be insulated by known means.

Notch 12 and slot 11 of terminal extension 9 work in concert to accommodate connector 3. A spring clip 19 engages notch 12. A lockable key 17 positioned on legs 16a engages slot 11. As a result, connector 3 can be firmly held in place on housing 50. Although such closure means such as the clip/notch combination and section/slot combination are described herein, various other configurations of closures are also possible in conjunction with, or independently from, one another.

As in the case of cover 7, extension 9 can be suitably dimensioned so that connector 3 may fit flush with housing 50 when in use. In addition, surface 18 of connector 3 may be designed to conform to the dimensions of the space surrounding terminal extension 9.

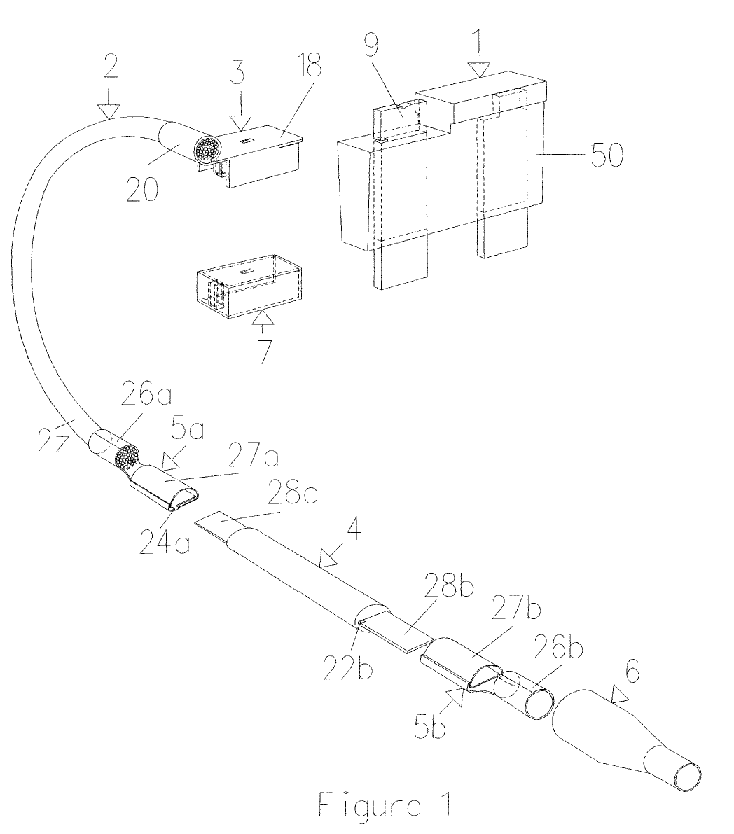

In this embodiment, a tube terminal 20 can extend from surface 18 and provide a point of connection for a wire 2 (see FIG. 1). Tube terminal 20 may be bent at the juncture with the contact section to accommodate installation requirements. Although a tube terminal has been described, any known method of construction or method of connecting a wire to connector 3 could also be employed. In addition, seals/insulation could be appropriate depending on the application.

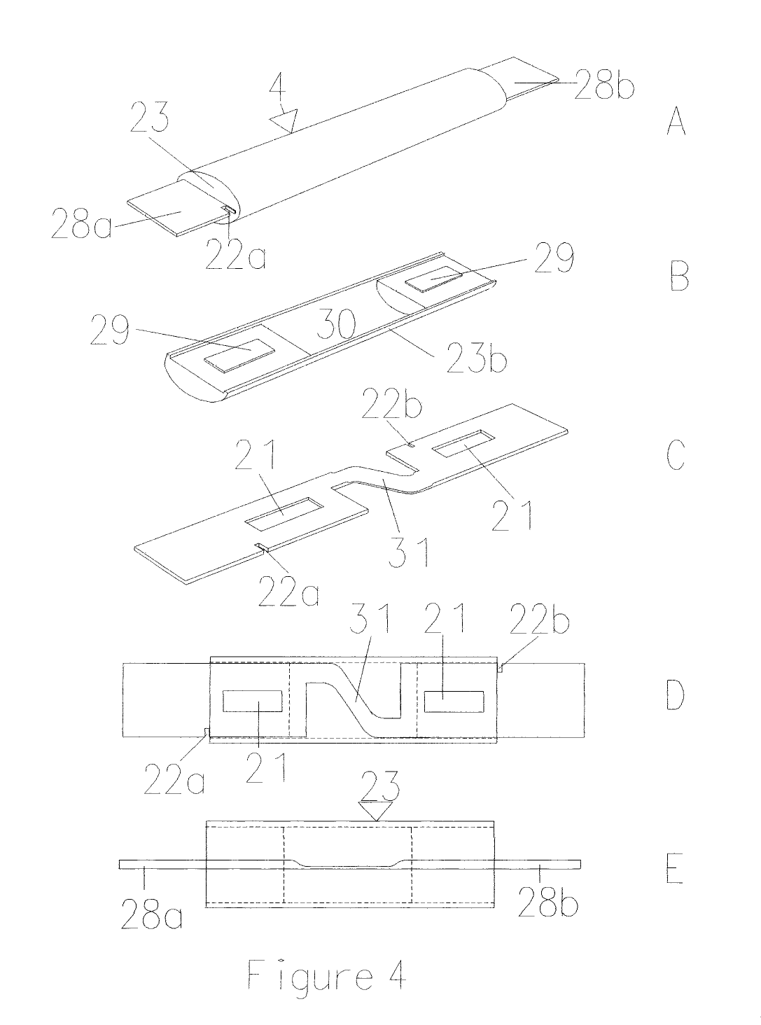

FIGS. 4A, 4B, 4C, 4D, 4E illustrate one embodiment of the disclosed linear circuit fuse 4. The disclosed device comprises a modified linear fuse having an elliptically-shaped fuse unit (or shell) 23 and two electrodes 28a, 28b. A half shell 23b comprises two positioning projections 29 capable of engaging receiving slots 21 of electrodes 28a, 28b (see FIGS. 4B, 4C). Half shell 23b further comprises void space 30 capable of enclosing fuse link 31. Retaining slots 22a, 22b engage locking pins 24a (see FIG. 1) and 24b (not shown) respectively to secure fuse 4 to a corresponding connector 5. Thus, linear fuse 4 comprises two half shells 23, each half shell having a void capable of housing a portion of fuse link 31. A half shell could comprise one or more positioning projections 29 capable of engaging a respective receiving slot such that when the half shells are fused or otherwise fastened together, the electrodes 28a, 28b extend from the enclosure to form male terminals. It is contemplated that the modifications disclosed herein provide for a smaller, more compact fuse unit. Although fuse unit 23 is shown having an oval shell form, any suitable shape or configuration could be employed.

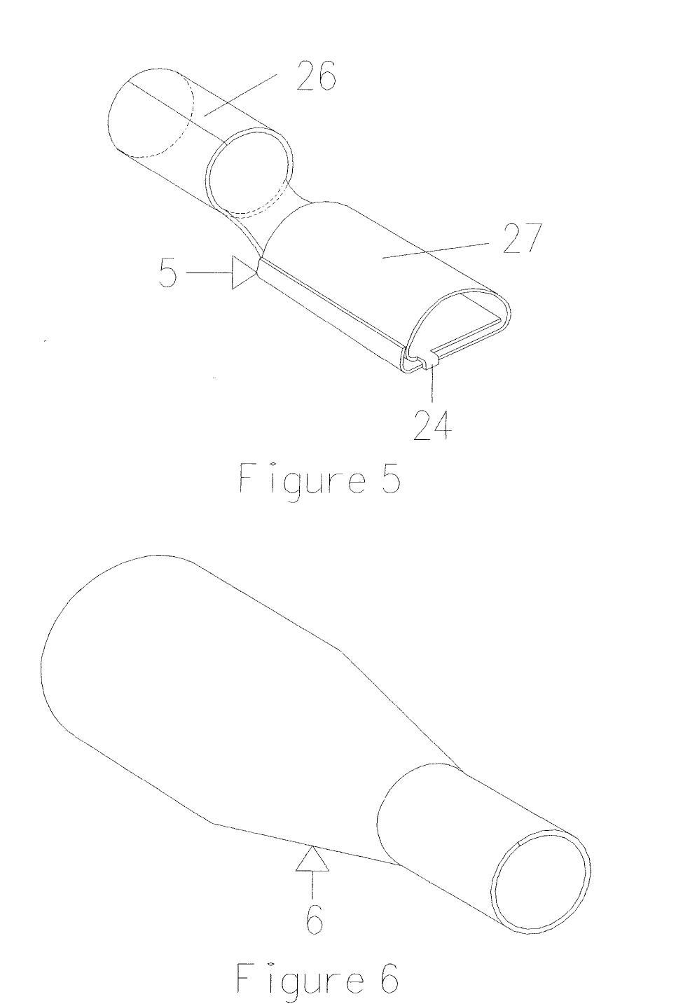

As shown in FIG. 5, a female electrode having a tubular power part 26 extends downwardly and outwardly to form a male electrode receiver 27. A locking pin 24 operates to secure connector 5 to the fuse terminal to which it is to be attached. Thus, as shown in FIG. 1, a distal end 2z of wire 2 is connectable to power part 26a of latchable connector 5a. An end of a load wire (not shown) is connectable to power part 26b of latchable connector 5b. Locking pin 24a and retaining slot 22a (not shown) operate to secure connector 5a to a corresponding end of fuse 4.

Referring now to FIG. 1, the present system 200 comprises a vehicular fuse 1 having a modified fuse housing 50 and a removable cover 7. Cover 7 can be removed if and when a connector is to be used, e.g., another circuit is desired. In conjunction with the description above, connector 3 can be referred to as a double U connector. Device 1 is shown connectable to wire 2 by means of connector 3. Device 1 is also shown to be capable of communication with a line fuse (or linear fuse) 4 (see also FIGS. 4A-4E) by means of latchable connectors 5 (see also FIG. 5). As stated above, distal end 2z of wire 2 is connectable to power part 26a of latchable connector 5a. Electrode 28a (or male terminal) is connectable to male receiver 27a of latchable connector 5a. In turn, electrode 28b (or male terminal) is connectable to male receiver 27b of latchable connector 5b. Locking pin 24b (not shown) and retaining slot 22b operate to secure connector 5b to electrode 28b of fuse 4.

As stated above, sealing boots can be mounted on the latchable connectors and the fuse ends to seal the fuse unit. The boot shown in FIGS. 1, 6 can be formed of a flexible material so as to enable the secure fit of over the wire or over the fuse end.

The materials suitable for use with the components of the disclosed device can comprise non-conductive silicon, carbonate, halocarbon or other polymer usable commercially in the manufacturing of vehicles fuses. The electrodes, electrode base and fuse segment materials can be any metal or metal alloy, normally used in vehicle fuse manufacture. The covers can be of the same or different materials where attached to the shells including but not limited to flexible material, e.g., a silicone polyurethane, or natural rubber.

Those having skill in the art will recognize that the size and thickness of the various components will be engineered to carry an appropriate power, i.e., amperage and voltage.

Although the disclosed device and method have been described with reference to disclosed embodiments, numerous modifications and variations can be made and still the result will come within the scope of the disclosure. No limitation with respect to the specific embodiments disclosed herein is intended or should be inferred.

I claim:

1. A vehicular fuse comprising:
a housing enclosing at least a portion of each of a bus electrode and a circuit electrode;
an end of said bus electrode extendable through said housing for connection to a wire, thereby forming a terminal extension; and
a removable cover capable of being detached to expose a portion of said terminal extension for connection with a connector capable of communicating with a load.

2. The device of claim 1, wherein said terminal extension further comprises a locking groove to engage a clip of said removable cover.

3. The device of claim 1, wherein said removable cover further comprises a formed section to engage a slot of said terminal extension.

4. The device of claim 1, wherein said removable cover is reusable.

5. The device of claim 1, wherein said removable cover can fit flush with said housing in use.

6. The device of claim 1, wherein said connector further comprises at least one contact surface capable of engaging a surface of said terminal extension.

7. The device of claim 6, wherein said terminal extension further comprises a mechanical lock to engage said connector.

8. The device of claim 6, wherein said connector further comprises a mechanical lock to engage said terminal extension.

9. The device of claim 6, wherein said connector can fit flush with said housing in use.

10. The device of claim 6, wherein said connector further comprises a terminal to provide a point of connection for said wire.

11. The device of claim 1, wherein said connector further comprises a pair of U-sections capable of receiving said terminal extension between each of said U-sections.

12. The device of claim 1, wherein said terminal extension may be insulated.

13. The device of claim 6, wherein said housing further comprises a groove to engage a clip of said connector.

14. A fuse assembly comprising:
a fuse having a shell capable of housing at least a portion of a pair of electrodes which are continuous with a fuse link;
said shell further comprising two halves, each of said halves comprising positioning projections to engage a corresponding number of receiving slots located on said pair of electrodes and a void space to enclose said fuse link;
wherein a respective end of said pair of electrodes extends beyond a terminus of said shell, thereby forming a pair of male terminals; and
wherein each of said pair of electrodes further comprises a retaining mechanism, each retaining mechanism mateable with a lock located on a connector.

15. The device of claim 14, wherein said connector further comprises a power part connectable to a source of electrical power and a male electrode receiver capable of receiving one of said pair of male terminals.

16. The device of claim 15 further comprising a sealing boot mountable on said connector to seal said male terminal received in said male electrode receiver.

17. The device of claim 14, wherein each of said male terminals is mateable with a male electrode receiver of a latchable connector, each of said latchable connectors further comprising a power part connectable to a wire.

18. A fused power interceptor comprising:
a bus electrode having two ends;
one of said ends extendable through a housing to form a terminal extension for connection to an electrical circuit;
a first connector capable of being attached to said terminal extension and a wire capable of communicating with said electrical circuit;
wherein a distal end of said wire is connectable to a power part of a second connector;
said second connector further comprising a male electrode receiver capable of receiving a male end of a linear fuse; and
wherein said linear fuse comprises a connection with said electrical circuit.

19. The device of claim 18, wherein said bus electrode further comprises a housing having a removable cover capable of being detached to expose said terminal extension for connection with said first connector.

20. The device of claim 18, wherein said connector further comprises a pair of U-sections capable of receiving said terminal extension between of each of said U-sections.

21. The device of claim 18, wherein said second connector further comprises a mechanical lock mateable with a retaining mechanism located near an end of said male end of said linear fuse to removably fasten said second connector to said linear fuse.

22. The device of claim 18, wherein said linear fuse further comprises a shell capable of housing at least a portion of a pair of electrodes which are continuous with a fuse link, said shell further comprising two halves, wherein either or both of said halves can comprise positioning projections to engage a corresponding number of receiving slots located on said pair of electrodes and a void space to enclose said fuse link.

23. The device of claim 18, wherein said terminal extension may be insulated.

24. A fused power intercept circuit comprising:
a vehicular fuse connectable to a wire and attached thereto by means of a double U connector;
a distal end of said wire being connectable to a line fuse using a first latchable connector; and
wherein a second latchable connector can join a load wire to said system.

25. The circuit of claim 24, wherein said vehicular fuse further comprises a terminal extension extendable through a housing, said housing further comprising a removable cover capable of being detached to expose a portion of said terminal extension for connection with said double U connector.

26. The circuit of claim 24, wherein said first latchable connector further comprises a power part capable of housing a wire and a receiver to receive a terminal end of said line fuse.

27. The circuit of claim 24, wherein said second latchable connector further comprises a power part capable of housing said load wire and a receiver to receive a terminal end of said line fuse.

28. The circuit of claim 25, wherein said terminal extension may be insulated.

29. A vehicular fuse comprising:
a housing enclosing at least a portion of each of a bus electrode and a circuit electrode;
an end of said bus electrode extendable through said housing to form a terminal extension;
said terminal extension capable of being removably attached to connector communicating with a load; and
wherein said terminal extension may be insulated.
